(19) United States
(12) Patent Application Publication
(10) Pub. No.: US 2008/0241809 A1
(43) Pub. Date: Oct. 2, 2008

(54) GRAPHICAL USER INTERFACE AND METHOD FOR PROVIDING A LEARNING SYSTEM

(76) Inventors: Mary E. Ashmore, Dallas, TX (US); J. Alan Baumgarten, Lantana, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/045,607

(22) Filed: Mar. 10, 2008

Related U.S. Application Data
(60) Provisional application No. 60/906,069, filed on Mar. 9, 2007.

(51) Int. Cl. G09B 5/06

(52) U.S. Cl. 434/307 R

(57) ABSTRACT

An integrated learning system that provides teachers and students with an efficient teaching and learning environment. The system may include a graphical user interface that enables lesson content and instruction content to be displayed in different regions. The lesson content may be derived from an online source and instruction content may be provided by a learning system provider. The integrated learning system may enable teachers to sort and select pre-defined lessons and to assign the lessons for students to complete. The student may access the assigned lesson via the learning system and submit a completed assignment to the teacher via the learning system for grading and comment. The learning system provides the teacher with the ability to monitor student assignment progress and tabulate grades for students.

### CROSS REFERENCE TO RELATED APPLICATION

This application claims the benefit of priority from U.S. Provisional Application Ser. No. 60/906,069 filed on Mar. 9, 2007, entitled “Learning System and Method.”

### BACKGROUND OF THE INVENTION

Education of students has traditionally used text books and other print sources of information provided by education publishers. However, since the information age, essentially starting with the introduction of computers to schools and classrooms, information sources have expanded from textbooks to content stored on digital media. Initially, the information was stored on computer disks or on a server located on a network that remote terminals or computers could access. With the development and growth of the Internet as a source of information, however, education using computers to access the Internet has become an invaluable tool for teachers and students.

While computers and the Internet are helpful for student education, there are shortcomings for using these tools in classroom environments. First, the Internet is inefficient in its organization and challenging to manage students accessing the Internet from a class management standpoint. Second, conventional access to the Internet has been available via a conventional web browser, such as Microsoft Explorer®. Other web browsers have been utilized to enable students to access websites to which teachers tell students to access. Using conventional web browsers presents a problem for teachers as students may be slow typists, students may incorrectly spell domain name addresses, or students may decide to access websites not on a teacher's agenda. While filters may be installed within the classroom to prevent students from accessing age inappropriate material, these filters do not prevent access to websites not on a teacher's agenda, such as shopping websites. Third, while online information sources have become a valuable teaching tool, teachers are burdened with developing curriculums that utilize the content provided on the Internet. Teachers who use online information sources are further burdened by having to properly integrate content into a traditional education program, including projects, homework, and, of course, quizzes and tests. This integration of online content into a classroom setting is challenging and time consuming for teachers in addition to their other classroom responsibilities. For example, traditional curricula have been based on textbooks that were deemed to be grade appropriate (e.g., grades K-9, undergraduate college, postgraduate college, etc.). In the case of a teacher using online sources, the teacher must determine grade level of the online content. For example, content posted on a government website, which as the U.S. Department of Treasury, may be appropriate for 7th through 9th grade students due to the writing level, but a 5th grade teacher may decide to include the website in a curriculum. Standardization of online content among teachers and school systems, locally and across the country, is another challenge that is currently being faced. The same problems that exist for traditional education systems (e.g., grade school) also exist for non-traditional education systems, such as home schooling, corporate training, and other non-traditional education environments.

### SUMMARY

To overcome the problems that exist for teachers using online sources of information, the principles of the present invention provide for a system and method that provide for learning by providing an integrated learning environment. The system may include a graphical user interface that enables lesson content and instruction content to be displayed in different regions. The lesson content may be derived from an online source and instruction content may be provided by a learning system provider. The integrated learning system may enable teachers to sort and select pre-defined lessons and assign the lessons for students to complete. The student may access the assigned lesson via the learning system and submit a completed assignment to the teacher via the learning system for grading and comment. The learning system provides the teacher with the ability to monitor student assignment progress and tabulate grades for students.

One embodiment of a learning system and method includes a database configured to store lesson information associated with multiple lessons. The lesson information may include instruction content associated with the lessons. A processing unit may be in communication with the database and be configured to execute software. The software may be operable to cause a graphical user interface including multiple regions to be displayed on an electronic device of a student user. The graphical user interface may include a first region configured to display lesson content and a second region configured to display instruction content. Graphical control elements may also be displayed to enable the student user to control views of lesson information. The database may be accessed to locate instruction content of a lesson in response to receiving a request for a selected lesson from the student user using the electronic device in communication with the processing unit. The instruction content may be communicated to the electronic device being used by the student user for display in the second region. Location information of lesson content associated with the selected lesson may be communicated to the electronic device in response to the student user selecting the lesson. The electronic device, in response to receiving the location information, may use the location information to access and display the lesson content in the first region.

A graphical user interface may include a first region configured to display lesson content accessed from a first source location and a second region configured to display instruction content. The instruction content may include information to provide a student user with directions associated with the lesson content. The instruction content may be accessed from a second source location different than the first source location. In one embodiment, the second source location is a network location on the Internet.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary environment for a learning system provider to provide a learning system for educational systems and students to use for learning;

FIGS. 2A and 2B are illustrations of an exemplary network configuration to enable a learning system provider to manage educational training for students and education providers, such as schools;

FIG. 3 is a screen shot of an exemplary webpage for a student user to log into a learning system website provided by a learning system provider;

FIG. 4A is a screen shot of an exemplary home page of a student user;

FIG. 4B is a screen shot of another view of the exemplary home page 400 of FIG. 4A;

FIG. 5 is a block diagram of an exemplary website map of a learning system for a student user;

FIG. 6A is a screen shot of an exemplary prepare webpage of a lesson;

FIG. 6B is a screen shot of an exemplary learning webpage;

FIG. 6C is a screen shot of an exemplary practice webpage;

FIG. 6D is a screen shot of an exemplary apply webpage;

FIG. 7 is an illustration of exemplary database(s) and software applications used by the learning system;

FIG. 8 is a flow chart of an exemplary process to provide for learning;

FIG. 9 is an exemplary website map of the learning system for a teacher user;

FIG. 10 is a screen shot of an exemplary home page of a teacher;

FIG. 11 is an exemplary preview lessons webpage may provide the teacher user with the ability to preview lessons available on the learning system;

FIG. 12A is a screen shot of an exemplary assign lessons webpage that enables a teacher to assign lessons to students;

FIG. 12B is a screen shot of a second exemplary assign lessons webpage that provides the second step to assigning lessons to students;

FIG. 12C is a screen shot of a third exemplary assign lessons webpage that provides the third step for assigning lessons to students;

FIG. 13 is a screen shot of an exemplary assignment summary webpage for a particular class;

FIG. 14 is a screen shot of an exemplary student progress webpage that shows the progress of an individual student in completing assignments and grades for each of the assignments;

FIG. 15 is a screen shot of an exemplary grading webpage that enables the teacher to grade a lesson;

FIG. 16 is a screen shot of an exemplary answer key webpage that may include the title of the lesson and questions and model answers to the questions;

FIG. 17 is a flow diagram of an exemplary process for operation of the learning system related to assignments;

FIG. 18A is an add lesson webpage that allows a lesson developer to create a lesson; and

FIG. 18B is a screen shot of another add lesson webpage that enables a lesson developer to provide additional information associated with a lesson.

### DETAILED DESCRIPTION OF THE DRAWINGS

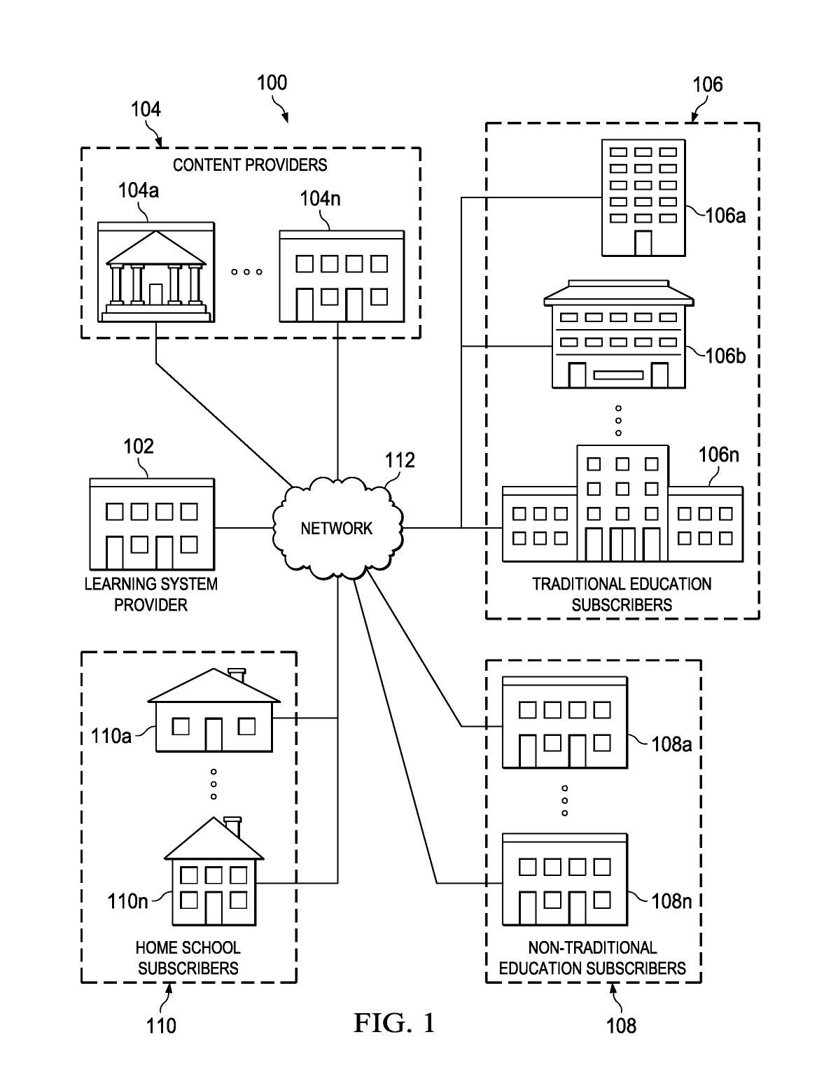

FIG. 1 is an illustration of an exemplary environment 100 for a learning system provider 102 to provide a learning system for educational systems and students to use for learning. The learning system provider 102 may enable content providers 104a-104n (collectively “104”) who generate learning content to be included by the learning system provider 102 for educational use. The content providers 104 may be conventional or traditional book publishers, web site publishers, governmental agencies, newspaper publishers, or any other content provider that generates or publishes content that may be used for education to students.

Users of the learning system may include traditional education subscribers 106a-106n (collectively 106), non-traditional education subscribers 108a-108n (collectively 108), and home school subscribers 110a-110n (collectively 110). The traditional education subscribers 106 may include individual schools 106a, such as those found in smaller or rural communities, and school systems 106b-106n. In the case of a school system, multiple schools may reside within the school system, where redundancy of grades and classes utilize the principles of the present invention for managing students and grading to improve efficiency within the school system. Non-traditional education subscribers 108 may include corporate training, continuing education programs, such as continuing legal education, and other non-grade school or university environments. Still yet, non-traditional education subscribers 108 may include companies, foundations, periodicals, non-periodicals, and all other non-education agencies that desire to include their or other content as “lesson content” for their subscribers or others to learn about a particular subject, such as global warming. Home school subscribers 110 may include children who are being schooled by their parents and adults who are taking course work via the Internet, for example. It should be understood that the principles of the present invention may be applied to many forms of education and learning and are not limited to traditional educational services provided by governmental or private education entities. In providing the learning system, communications over a network 112, such as the Internet, may be utilized to enable subscribers of the learning system to access a website or other graphical user interface.

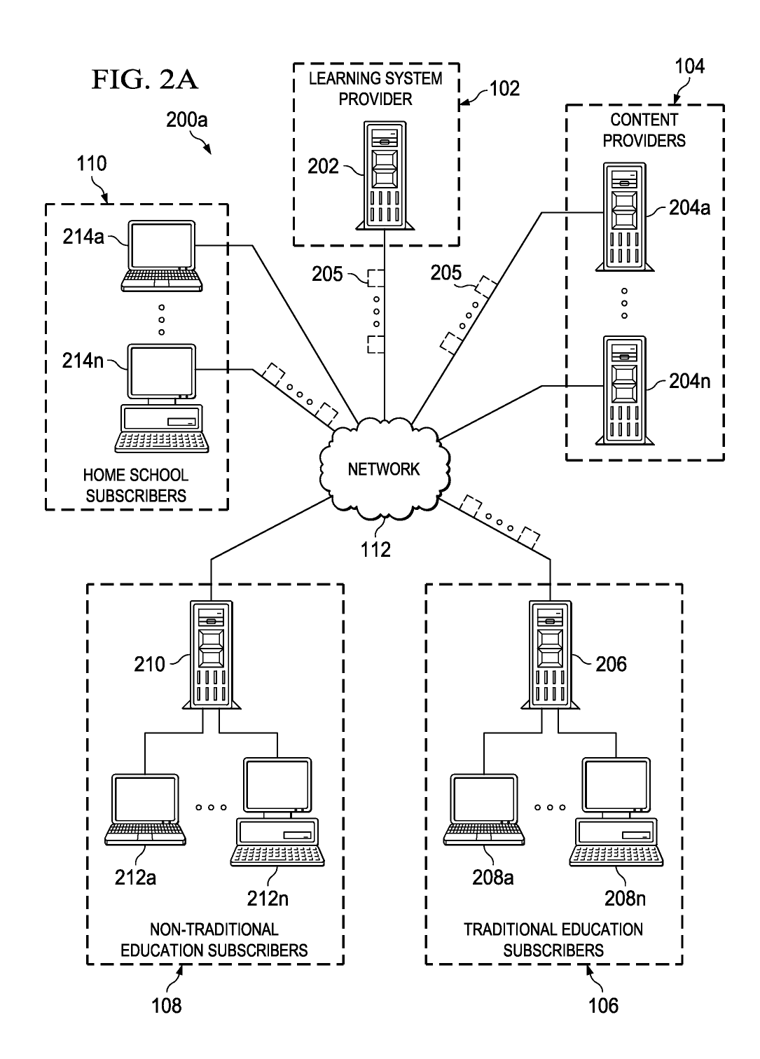

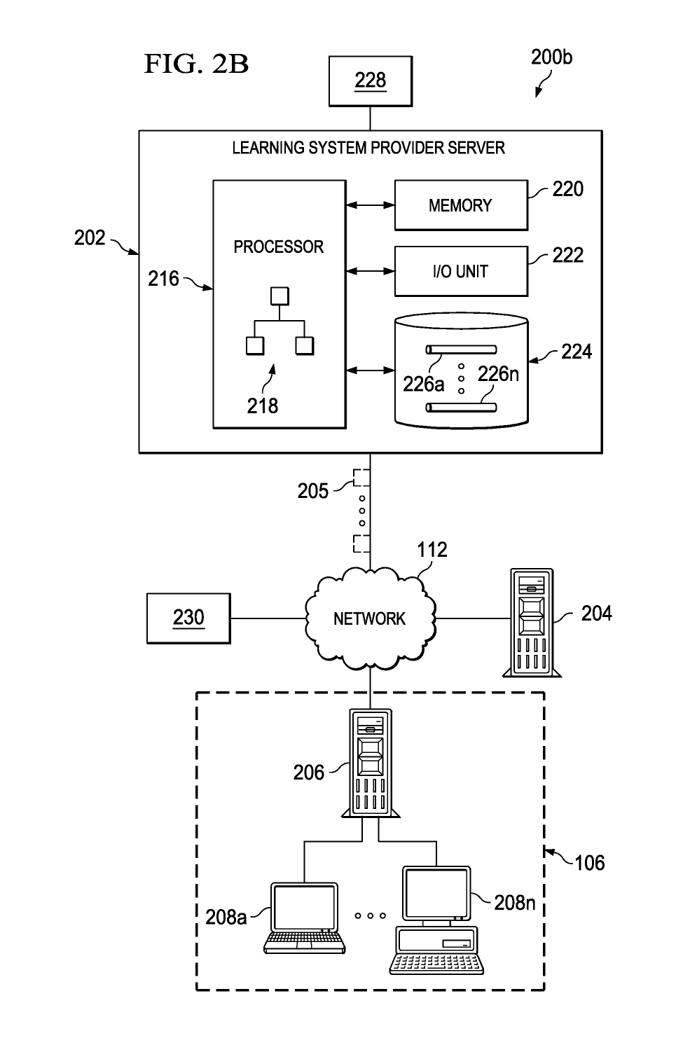

FIG. 2A is an illustration of an exemplary network configuration 200a to enable learning system provider 102 to manage educational training for students and education providers, such as schools. The learning system provider 102 may operate a server 202 to execute learning management software. Content providers 104 may respectively execute servers 204a-204n (collectively 204) that store content and, in one embodiment, display content on a website. The server 202 may communicate with the servers 204 via the network 112 to access content displayed on the websites hosted by the servers 204. The content, if used by the learning system provider 102 as educational information, may be included as presented by the content providers 104 or, alternatively, altered in format. The learning system provider 102 may create instructional content that provides instruction to student users for the content provided by the content providers 104. The learning system provider server 202 may communicate with the content providers servers 204 using data packets 205 to communicate data via the network 112, as understood in the art.

The traditional education subscribers 106 may have an administrator manage information associated with students and teachers for using the learning system. Laptop and desktop computers 208a-208n (collectively 208) may be utilized by students, and teachers may interface with the learning system provided by the learning system provider 102 via the server 206. Similarly, the non-traditional education subscribers 108 may utilize the same or similar configuration of server 210 being used to provide hosting services for computers 212a-212n (collectively 212) used by students. Alternatively, the students may connect directly to the network 112 from a work or home location. Home school subscribers 110 may use computers 214a-214n (collectively 214) for communicating with the learning system provider server 212 via the network 112.

In operation, the learning system provider 102 provides an integrated system by which learning content, which may be provided by traditional educational publishers and non-traditional educational publishers (i.e., content providers), may be organized into a lesson and assigned to students via the learning system. The learning system provider 102 may provide instruction content that is associated with learning content provided by content providers 104 and used by the learning system provider 102 in lessons for students. The learning system provider 102 may organize the lesson content into traditional grade levels, subject, and discipline, for example. As an example, a subject may be Social Studies, a discipline within the Social Studies subject may be U.S. History, a Unit within the U.S. History discipline may be The Civil War, and a lesson within The Civil War unit may be Grant and Lee. A teacher may search for lessons as categorized by grade levels, subjects, and discipline, and assign the lessons to students. The students may access assignments assigned to them on their respective home pages within the learning system.

FIG. 2B is an illustration of a more detailed network configuration 200b showing an expanded view of the server 202. As shown, the server 202 includes a processing unit 216 that executes software 218. The software 218 may be configured to operate a learning system, as described herein. In addition, the software 218 may include filters that operate to prevent websites, webpages, contact, images, or any other information deemed to be age inappropriate from being accessible or displayed to users of the learning system. The processing unit 216 may further be in communication with a memory 220, input/output (I/O) unit 222, and storage unit 224. The storage unit 224 may store data repositories 226a-226n (collectively 226), which may be databases, for storing information and content utilized by the learning system. A computer 228 operated by an employee of a learning system provider may be utilized to create lessons available for teachers to assign to students. Similarly, a computer 230 that communicates with the server 202 may be utilized by an outside consultant or employee working remotely to create lessons.

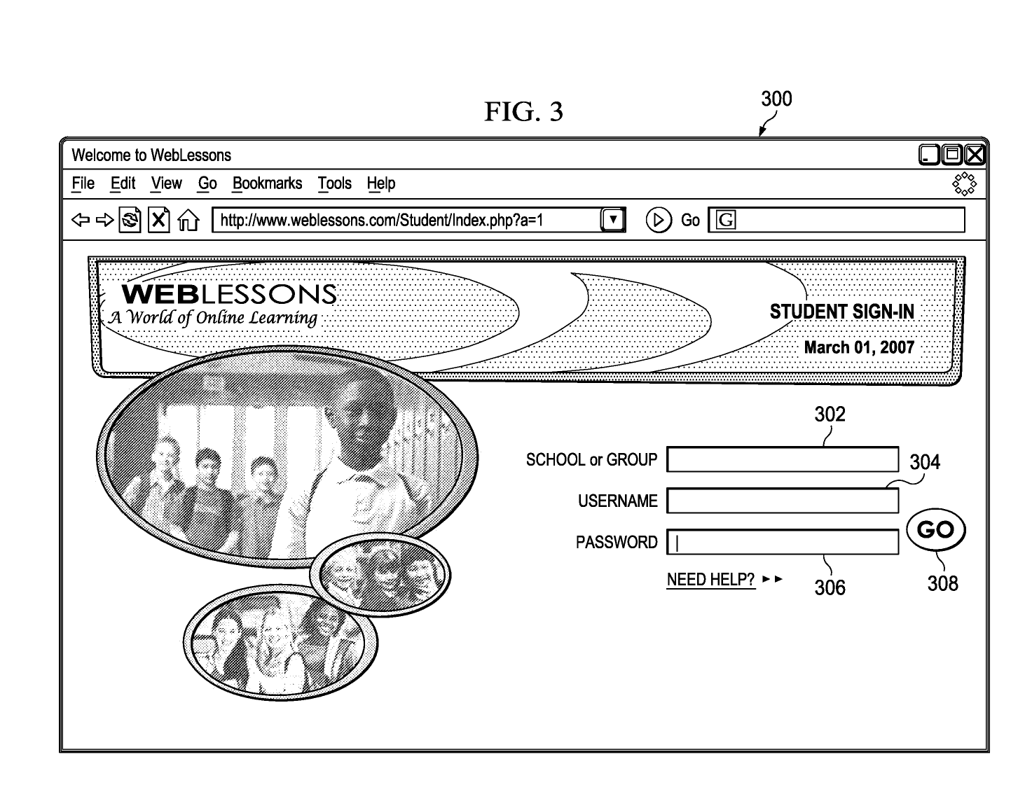

FIG. 3 is a screen shot of an exemplary webpage 300 for a student user to log into a learning system website provided by a learning system provider. The webpage 300 may include an optional school or group text entry field 302 for the student user to enter a school or group name or identification. The use of a school or group ID may enable students from different schools or groups to have the same names (e.g., Sharon S) to make it easier for students to remember their user names. A username text entry field 304 and password text entry field 306 may also be provided to enable each student to maintain privacy of their information from other students. A soft-button 308 may be provided for the student user to select for submission of the information in the text entry fields 302, 304, and 306.

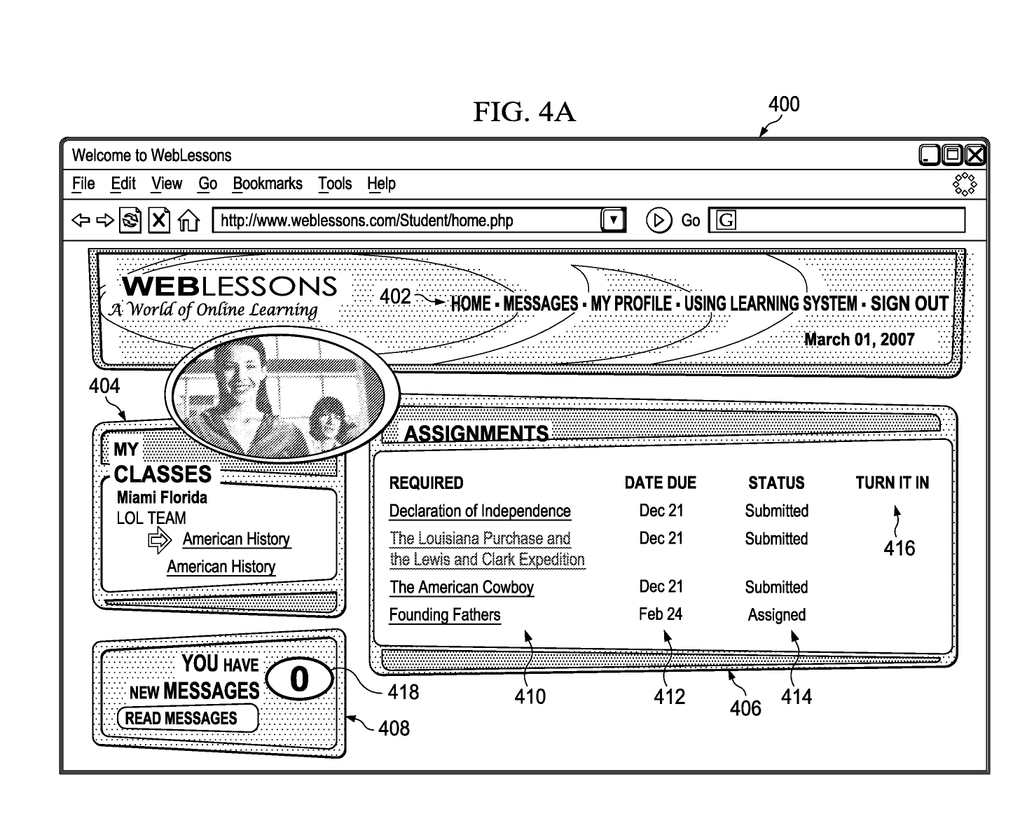

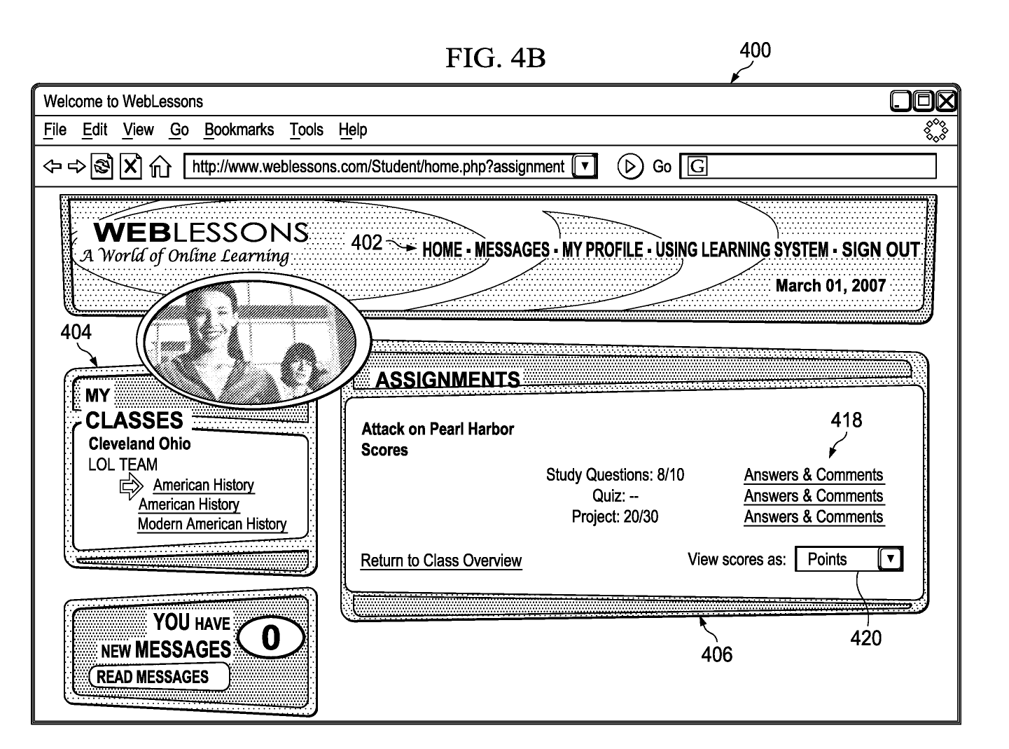

FIG. 4A is a screen shot of an exemplary home page 400 of a student user. The home page 400 may include a number of selectable options 402 to enable the student user to view or perform particular functions. The selectable options 402 may include “home,” “messages,” “my profile,” “using learning system,” and “sign out.” Each of these options may be provided to the student user as hyperlinks or in another format (e.g., pull-down menu) as understood in the art. The “messages” option may cause a messages page (not shown) to be displayed. The messages page may include emails that have been communicated to the student from a teacher or the system, and vice versa. Optionally, the system may enable communications from other students. For example, students that are formed as a team for a project may have email communication privileges. The “my profile” option may enable the student user to set up or change his or her profile. For example, the profile may include telephone number, birthday, parent names, parent email addresses, and other information associated with the student. The “using learning system” option may provide instructions to the student user for using the learning system website. The “sign out” option enables the student user to log off of the website.

The webpage 400 may include a number of information regions, including “my classes” region 404, “assignments” region 406, and “new messages” region 408. The region 404 may provide a list of classes in which the student user is enrolled. The region 406 may provide an assignment 410 that the student user current has assigned, associated due dates 412, status 414 of each assignment (e.g., “submitted,” “assigned,” “in progress,” “complete,” “graded,” etc.), and “turn it in” list 416 that presents selectable elements associated with each assignment 410 to enable the student user to submit an assignment when complete and ready for submission to the teacher via the learning system. The messages region 408 may display a number 418 that is indicative of new messages that are sent to the student user from a teacher or the learning system. For example, in response to the teacher grading a student's assignment, a message may be sent to the student user with the teacher's comments and grade of the student's assignment. The system may send the student user a receipt notification in response to the student being enrolled in a class, for example.

FIG. 4B is a screen shot of another view of the exemplary home page 400 of FIG. 4A. The home page 400 shows an assignment, “Attack On Pearl Harbor,” in the “assignments” region 406 in response to a student user selecting an assignment that has been graded. The assignment has received a grade of “8/10” for the study questions and “20/30” for the project. The student user may view the answers he or she submitted and the comments provided to those answers from the teacher by selecting a hyperlink “Answers & Comments” in a list 418 associated with respective study questions, quiz, and project of the assignment. A pull-down menu 420 may enable the student user to view the scores as points, percentages, grades, or otherwise.

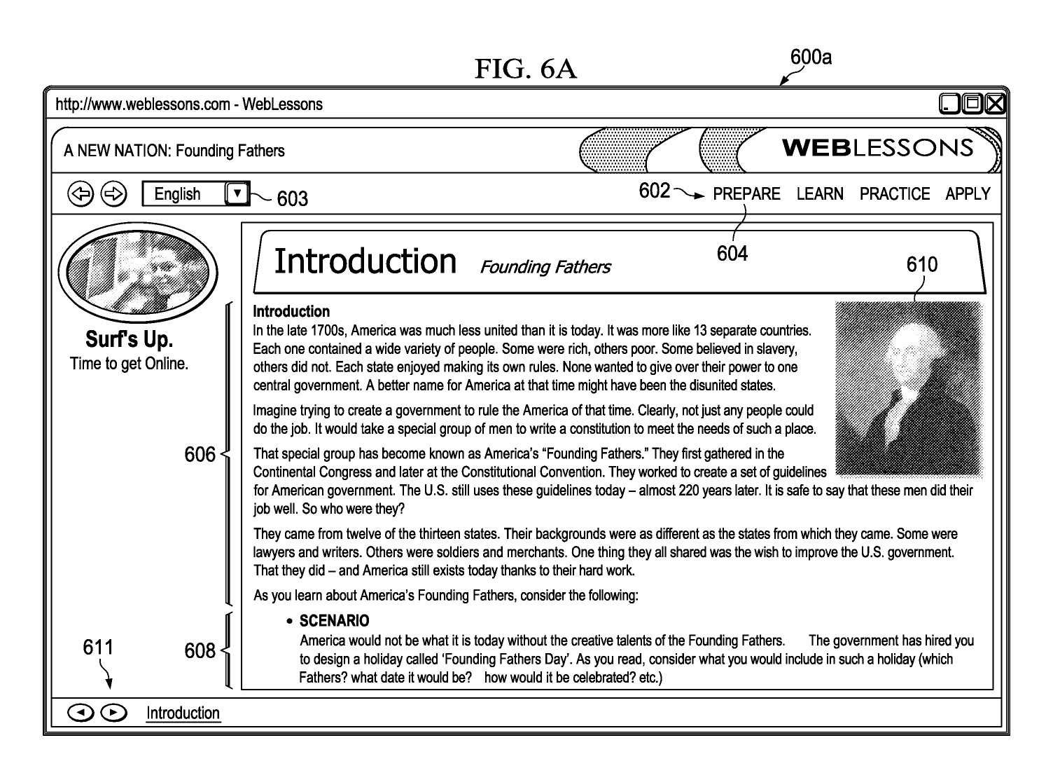

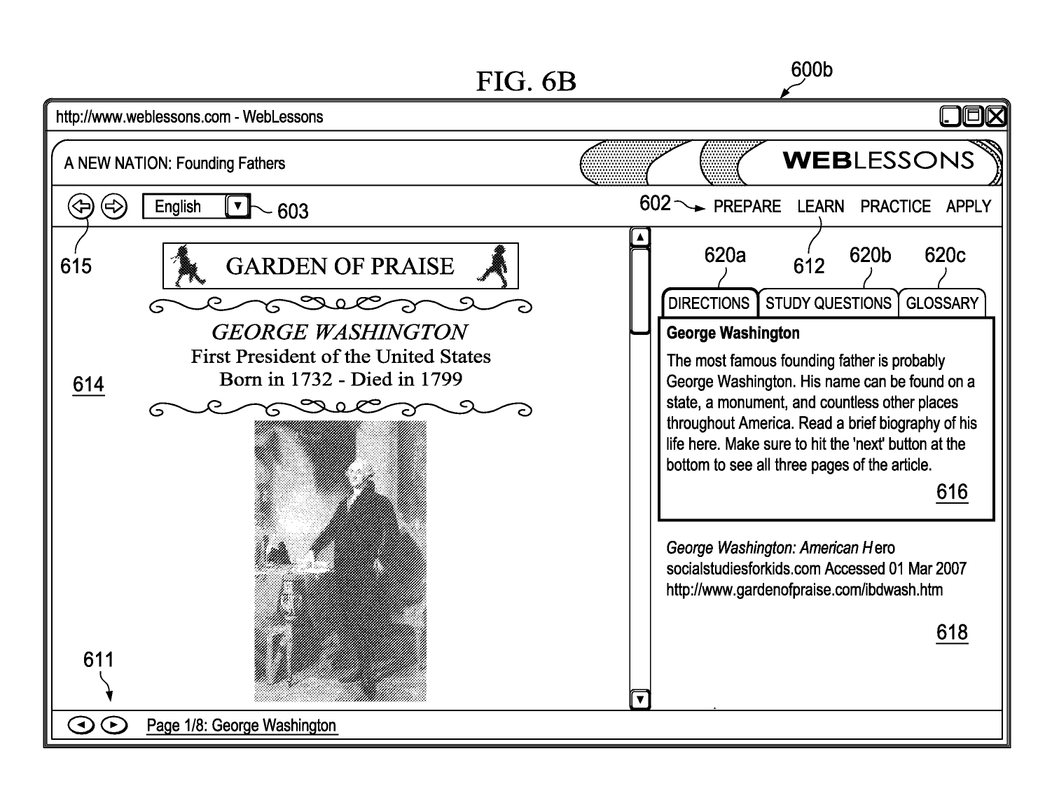

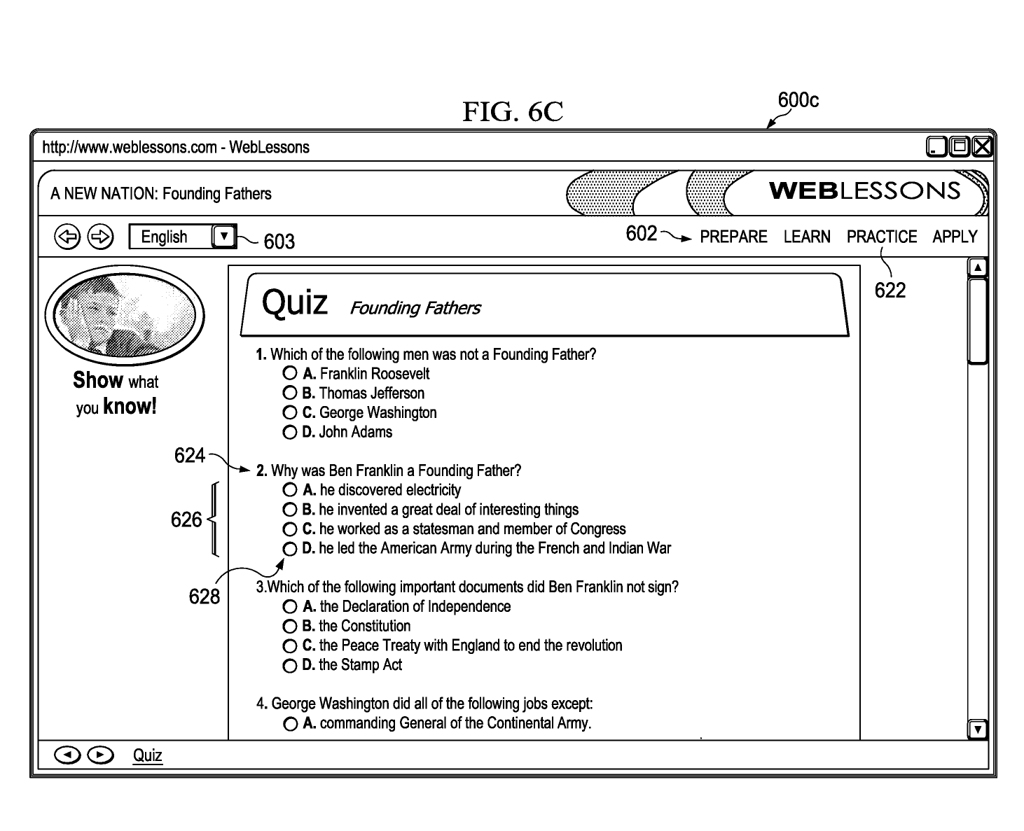

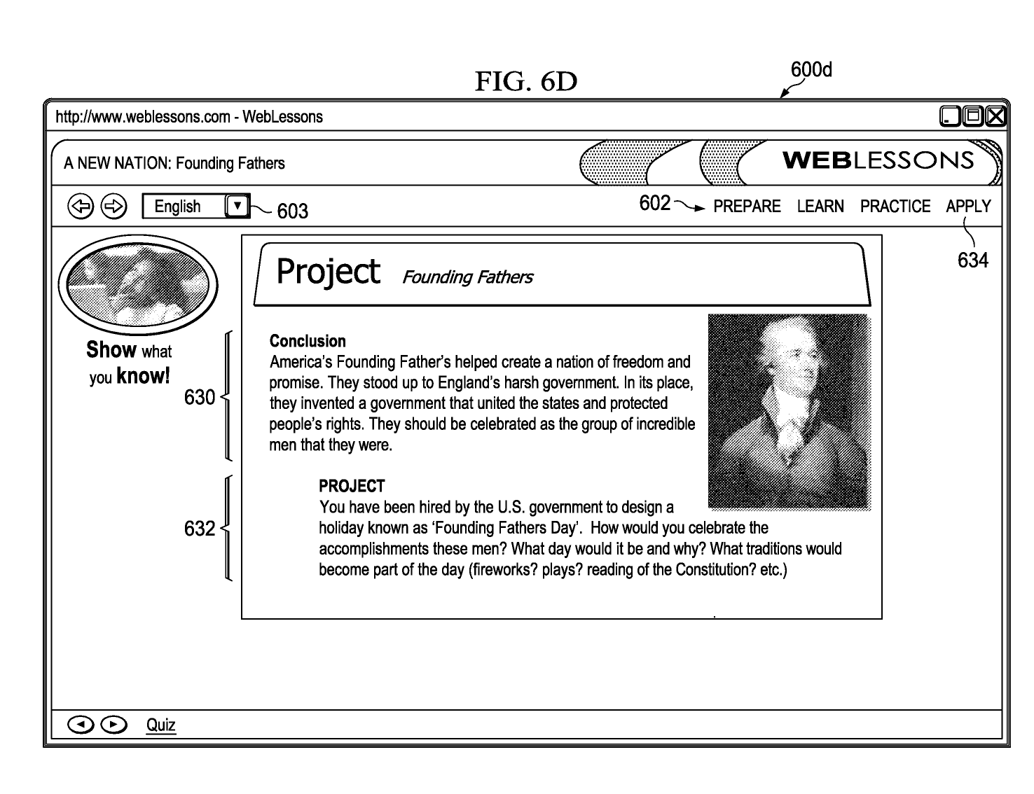

Continuing with FIG. 4A, a student user may perform a lesson or assignment by selecting the name of an assignment. For example, the student user may select “Declaration of Independence” by using a mouse to click on the name. In response, the learning system operating on a server may be requested for a URL of the lesson content for lesson content to be displayed to the student user (FIGS. 6A-6D). In one embodiment, rather than entering into the lesson directly, a pre-quiz may be given to the student to test the student's knowledge prior to performing the assignment. The pre-quiz may be the same or different from a quiz that follows learning information of the assignment, such as a quiz shown in FIG. 6C. The pre-quiz may provide general or specific questions or other knowledge tests associated with a lesson. By providing a pre-quiz, measurement of a student's initial and increased knowledge may be collected and used for statistical purposes for the student and in the aggregate for educators.

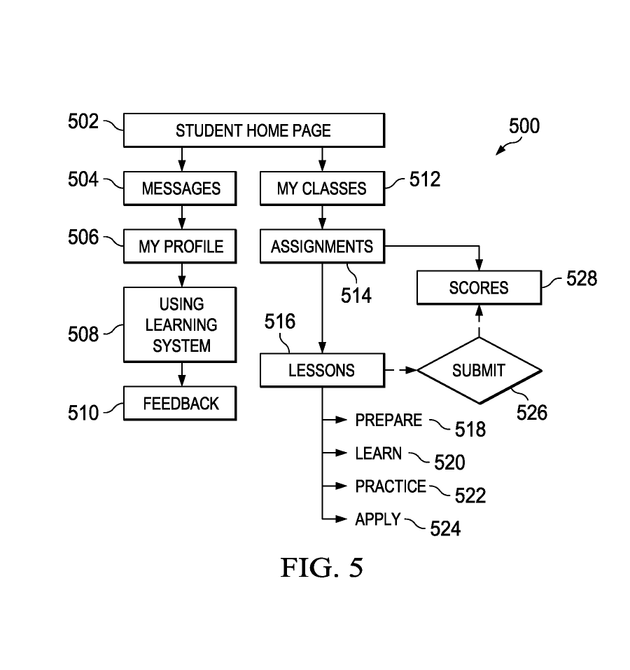

FIG. 5 is a block diagram of an exemplary website map 500 of a learning system for a student user. The webpage map 500 starts at a student home page 502, which the student accesses after logging into the learning system. The student home page 502 provides the student with a number of selectable options, including accessing “messages” option 504, “my profile” option 506, “using learning system” or website instructions option 508, and “feedback” option 510. These options may be accessible directly from the home page 502 via a hyperlink or embedded within other pages of the learning system. It should be understood that other functions and information may be provided and accessed by the student user that relates to the student user's learning experience.

The student home page 502 may also provide the student user with the ability to select a “my classes” option 512. The “my classes” option 512 may provide the student user with a list of classes in which the student user is enrolled. A list of assignments 514 may be listed, optionally arranged by classes, for the student user to view. The student user may select the assignments, via hyperlinks or otherwise, and perform lessons 516 associated with the respective assignments 514.

A lesson may be organized as a sequence of events that constitute an instructional model, as understood in the art. The sequence of events may include prepare 518, learn 520, practice 522, and apply 524. Instructional models have traditionally included more steps. The use of four events or steps makes learning relatively easy to manage and more acceptable to student users who tend to relate more easily to fewer steps in a computer learning environment. The four events are described further herein with respect to FIGS. 6A-6D.

After a student user has completed a lesson by working through each of the four events, the student user may select to submit the completed assignment at a submit step 526. The dashed arrows connected to the submit step 526 indicate that a teacher and/or learning system becomes involved in response to the student user submitting the assignment. The assignment may be graded by the teacher or learning system and available to the student user at the scores step 528. The scores step 528 may enable the student to select a particular assignment to view the score for the assignment and read any feedback for the assignment.

FIG. 6A is a screen shot of an exemplary prepare webpage 600a of a lesson. The prepare webpage 600a is used to activate background knowledge for a student user so that the student mentally engages the lesson. This webpage 600a represents the prepare step 518 (FIG. 5) of the sequence of events. The prepare webpage 600a may display each of the events identifier 602 of the learning process and highlight or otherwise indicate the particular step at which the student user is currently engaging. The student user may select a language to view the lesson via a pull-down menu 603. In this case, event identifier 604, which reads “PREPARE,” is highlighted to notify the student user that he or she is at the prepare step. The prepare webpage 600a may include an introduction section 606 and scenario section 608. The introduction section 606 may include background information associated with the lesson being taught to the student user. In addition to the introduction section, a scenario section 608 may be provided as a follow up to the introduction section 606 to engage the student user in the lesson. An image 610 may be provided to illustrate to the student user something or someone, in this case George Washington, representative of the lesson. The image 610 may be in the form of a photograph, video, graphic, interactive image, or otherwise, to cause the student user to better begin to comprehend the lesson. Control elements 611, such as forward and back arrows, may be provided to enable the student user to page through the information presented in the prepare step.

FIG. 6B is a screen shot of an exemplary learning webpage 600b. The learning webpage 600b is used to teach the student user a lesson. The learning webpage 600b represents the learn step 520 (FIG. 5) of the sequence of events and reminds the student user the step that he or she is currently working in the learn step by highlighting an event identifier 612, in this case “LEARN.” The learning webpage 600b includes a first region 614 that may display lesson content and a second region 616 that includes instruction content. The first region 614 may be considered a portal, where another website may be displayed. This configuration may be considered a “browser within a browser.” Neither browser includes an address field so as to limit a student's ability to access another site while performing a lesson. The lesson content may include text, graphics, rich media, video, audio, or any other visual or non-visual information that may be helpful for a student to learn about a topic. The lesson content, if the source content is from another webpage, may have the same or substantially the same pagination as the other webpage. The user may use the control elements 611 to move forward or back through the pages of the lesson content. In one embodiment, hyperlinks that exist on the source website are also included in the first region 614 and may be selected to cause the first region 614 to display the content at the hyperlink location. The student user may view the content at the hyperlink and return to the learn content by pressing a “back” control element 615, as understood in the art. In accordance with the principles of the present invention, the instruction content may include directions, study questions, and/or glossary information associated with the lesson content displayed in the first region. The instruction content may be in the form of text, graphics, audio, video, and the like. A third region may include a cite of the source of the lesson content being displayed.

FIG. 6C is a screen shot of an exemplary practice webpage 600c. The practice webpage 600c is used to re-enforce the lesson for the student user. The practice webpage 600c represents the practice step 522 (FIG. 5) of the sequence of events. In one embodiment, the practice webpage 600c includes a quiz. One form of a quiz includes multiple choice questions. For example, a question 624 may include multiple potential answers 626, where each of the answers 626 includes a respective control element 628, such as a radio soft-button, as understood in the art. The practice content may include text, graphics, rich media, video, audio, or any other visual or non-visual information that may be used to test the student user's knowledge of the lesson content. In one embodiment, after completing the quiz, the learning system may provide the student with a score to provide immediate feedback for the student user. Alternatively, the score may be provided after the entire lesson is complete, including a project described with respect to FIG. 6D. The practice webpage 600c provides for a post-quiz after the student reviews or otherwise studies the lesson content of the learning webpage 600b (FIG. 6B). By providing both pre- and post-quizzes, information of student knowledge and ability to learn may be collected by the learning system.

FIG. 6D is a screen shot of an exemplary apply webpage 600d. The practice webpage 600d is used to further re-enforce the lesson for the student user by including conclusion content 630 and project content 632. The practice webpage 600d represents the practice step 524 (FIG. 5) of the sequence of events. To remind the student user of the step that he or she is working, an event identifier 634, in this case “APPLY,” may be highlighted. The conclusion content may include text, graphics, rich media, video, audio, or any other visual or non-visual information that may be used to test the student user's knowledge of the lesson content. The project content 632 may instruct or request that the student user perform a project to complete the assignment. The project may be an online assignment complete with text entry fields that allow the student user to type an essay or short answer questions or request that the student user turns in a hard-copy of a completed project, such as a physical model of an object (e.g., airplane). After the student user completes the entire lesson, the student user may return to his or her home page 400 (FIG. 4) and select a “turn it in” element in the list 416 associated with the assignment list 410. To avoid confusion for the teacher and student, the student may be limited to a single submission of the lesson. The teacher may request that the student redo the assignment if, after reviewing the student's work, the teacher determines that the student's performance is incomplete or inadequate (e.g., a grade below 60 percent). Although each lesson may include a quiz, the learning system may further include an overall exam may be assigned to the student to cover multiple lessons, complete topics, and/or subjects.

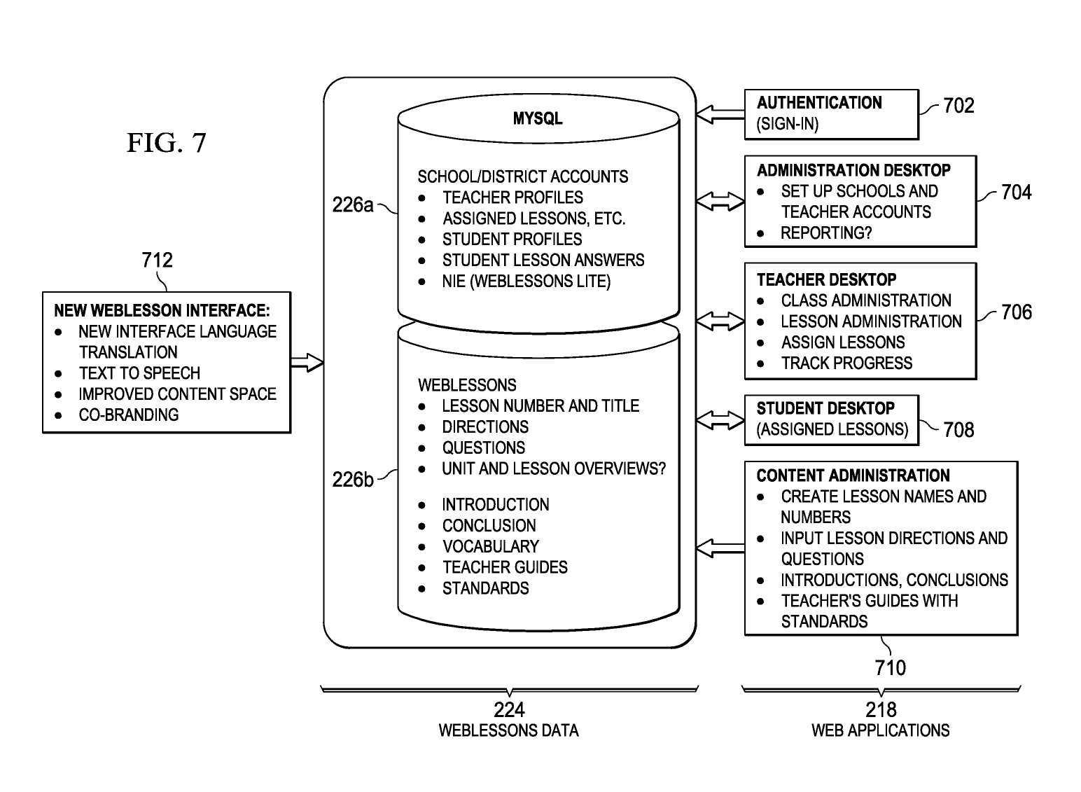

FIG. 7 is an illustration of exemplary database(s) 226 (FIG. 2) and software applications 218 used by the learning system. The databases 226 may be stored on the storage unit 224. The software applications 218 may perform certain functions for both the student user and teacher and access the databases 226 for storing and loading data stored therein. More specifically, the databases may include a first database 226a that includes school/district accounts. The school/district accounts may include teacher profiles, student profiles, assigned lessons, student lesson answers, and other information associated with the student lessons, including grades, homework assignments, quizzes, projects, and so forth. A second database 226b may include lessons information. The lessons information may include lesson number, lesson title, directions, questions, unit and lesson overviews, introduction, instructions, conclusion, vocabulary, teachers guides, standards, URL locations of learning content, and so forth. The lessons information may be information created by the learning system provider, third party, or content provider. As shown, lesson content is not stored in the exemplary embodiment of the database 226b as the lesson content is found on a content provider's website. However, it should be understood that the lesson content may be stored in the lesson database 226. It should further be understood that the databases 226 may be combined or further separated and provide the same or similar functionality.

The software applications 218 may include a number of functions, including authentication function 702, administrator desktop module 704, teacher desktop 706, student desktop 708, content administrator 710, and lesson interface 712. The authentication function 702 provides the login webpage 300 (FIG. 3) that accepts the login information and authenticates the user by accessing the database 226a to confirm that the user is a student or teacher user as provided by the student or teacher profiles. The administrator desktop function 704 enables an administrator to set up schools, teacher accounts, and reporting operations. The teacher desktop function 706 enables the teacher to administer classes, administer lessons, assign lessons, and track progress of students. The student desktop function 708 enables students to view and perform assigned lessons assigned by his or her teachers. The content administrator function 710 enables an administrator to create lesson names, lesson numbers, input lesson directions, lesson questions, lesson introductions, lesson conclusions, and teacher guides with standards (e.g., standard answers to lesson questions). The lesson interface function 712 may include language translations, text-to-speech function, alternative lesson region, and co-branding of schools, businesses, or otherwise. It should be understood that different and/or additional software functions may be provided for providing the learning system in accordance with the principles of the present invention.

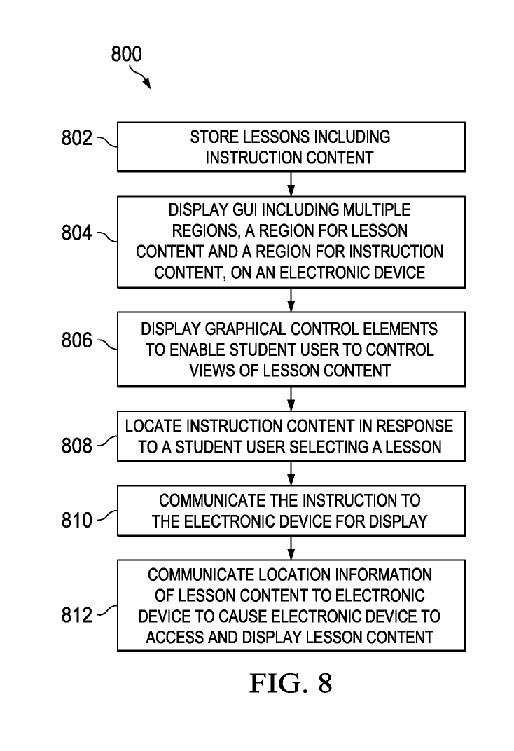

FIG. 8 is a flow chart of an exemplary process 800 to provide for learning. The process 800 may include storing lesson information associated with a multiple lessons at step 802. The lesson information may include instruction content associated with the lessons. At step 804, a graphical user interface may be displayed and include multiple regions on an electronic device of a student user. The graphical user interface may include a first region configured to display lesson content, a second region configured to display instruction content, and display graphical control elements to enable the student user to control views of the selected lesson information at step 806. The views may include particular pages of the lesson content. It should be understood that more than one region may be used to display the lesson content and the instruction content. Further, pop-up windows and second windows for displaying the instruction content are considered to be equivalent to a second region. At step 808, instruction content of a lesson may be located in response to receiving a request for a selected lesson from the student user using the electronic device. The instruction content may be located in a database provided by the learning system. The instruction content may be communicated to the electronic device being used by the student user for display in the second region at step 810. At step 812, location information of lesson content associated with the selected lesson information may be communicated to the electronic device in response to the student user selecting a graphical control element. In one embodiment, the location information of the lesson content may include a URL address for a website located on the Internet, where the lesson content may be authored by someone other than the author of the instruction content for the lesson content. The electronic device, in response to receiving the location information, may use the location information to access and display the lesson content in the first region associated with the instruction content displayed in the second region.

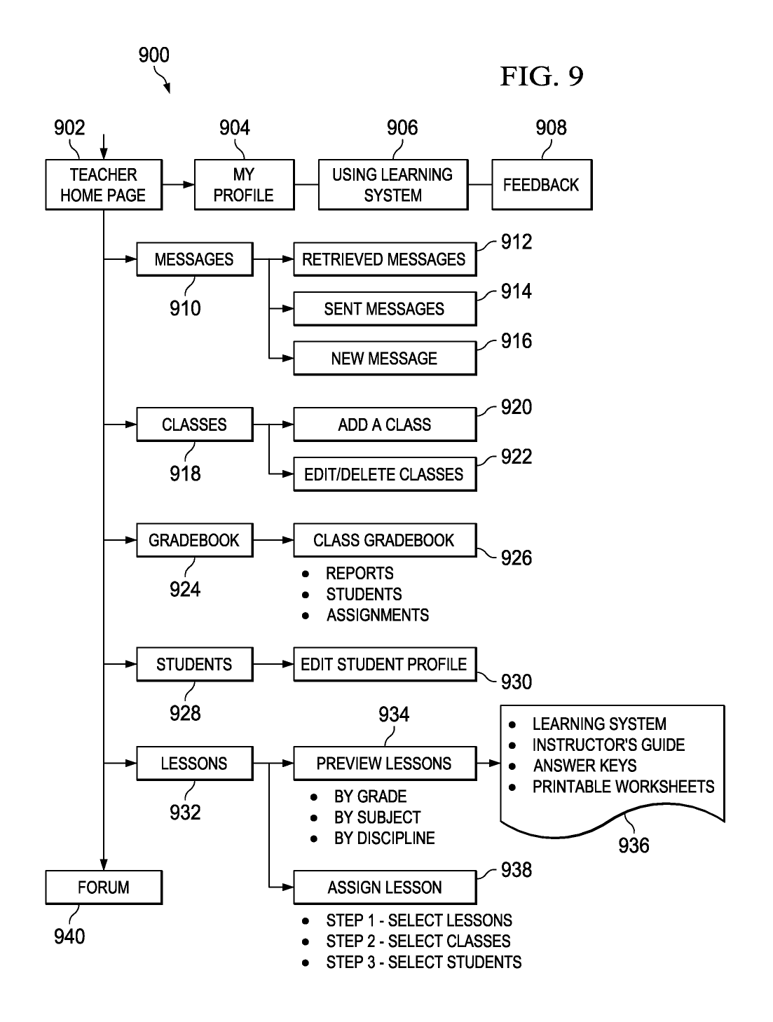

The learning system also provides teachers with the ability to perform teacher duties that generally include managing lesson assignments, classes, and grading. FIG. 9 is an exemplary website map 900 of the learning system for a teacher user. The website map 900 starts at the teacher home page 902, which the teacher accesses after logging into the learning system. The teacher home page 902 provides the teacher with a number of selectable options. A “My Profile” option 904 may provide a teacher with the ability to include profile information, such as name, home address, telephone numbers, email addresses, assigned grades, classes, photograph, and any other information that students, parents, and administrators may desire. A “Using Learning System” option 906 may provide the teacher user with a tutorial or other help information to teach or assist the teacher user to use the learning system. Because the teacher manages and grades students, the teacher's use of the learning system is more involved than that of the students. A “feedback” option 908 may provide the teacher with the ability to notify the learning system provide with any corrective comments to improve the learning system in case of software bugs or general improvement advice.

A “Messages” option 910 provides the teacher with the ability to retrieve messages 912 from students, administrators, parents, and/or the learning system, view sent messages 914, and create and send new messages 916. A “Classes” option 918 enables a teacher to manage his or her classes. The teacher may add a class 920 and edit or delete classes 922. A “Gradebook” option 924 provides the teacher with a list of class gradebooks 926 that provides the ability to grade student assignments, view student grades, create reports, and perform other functions associated with grading, such as monitoring class attendance.

A “Students” option 928 may enable the teacher to view and edit student profiles 930. The profiling editing ability may ensure that the teacher has control over content created by the students in their profiles.

A “Lessons” option 932 provides the teacher user with the ability to preview lessons by grade, subject, discipline, for example. The teacher also has the ability at option 936 to view an instructor's guide for each lesson, view answer keys for the lessons, and create printable worksheets for the teacher to prepare for a lesson. The teacher may also assign lessons 938 by selecting a lesson, selecting class(es) to assign the lesson, and select student(s) to assign the lesson. These selection options provide the teacher with flexibility to assign lessons to individual or groups of students. One use of such a lesson assignment process includes assigning more advanced lessons to students who excel beyond the average student. In one embodiment, a teach review element (not shown) may enable a teacher to provide a review about a particular lesson for other teachers to read when deciding which lessons to select. The review may be in any form, grade, indicia (e.g., stars), or text.

A “Forum” option 940 provides the teacher user with a forum to engage other teachers within his or her school, school system, region, or nationally. The forum may operate as a bulletin board, chat site, instant message, or otherwise so that the teacher user can be part of a community that uses the learning system.

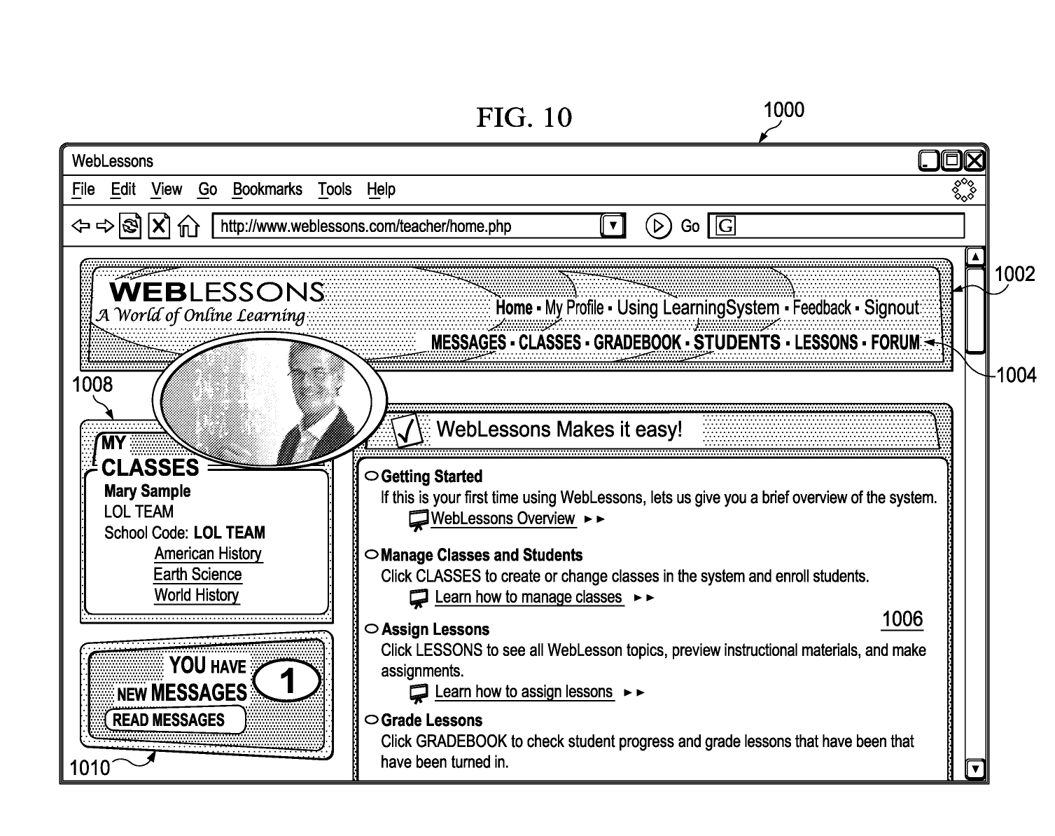

FIG. 10 is a screen shot of an exemplary home page 1000 of a teacher. The home page 1000 may include a number of selectable options 1002 and 1004 that provide the teacher user functionality as described with respect to FIG. 9. A main region 1006 may display information associated with a selected option, in this case the “Using Learning System” option was selected. In addition, a region 1008 may list classes that the teacher is responsible (e.g., American History, Earth Science, and World History). Another region 1010 may provide the teacher with the ability to access messages, such as email messages. It should be understood that other messaging types may be available to the teacher, including instant messaging.

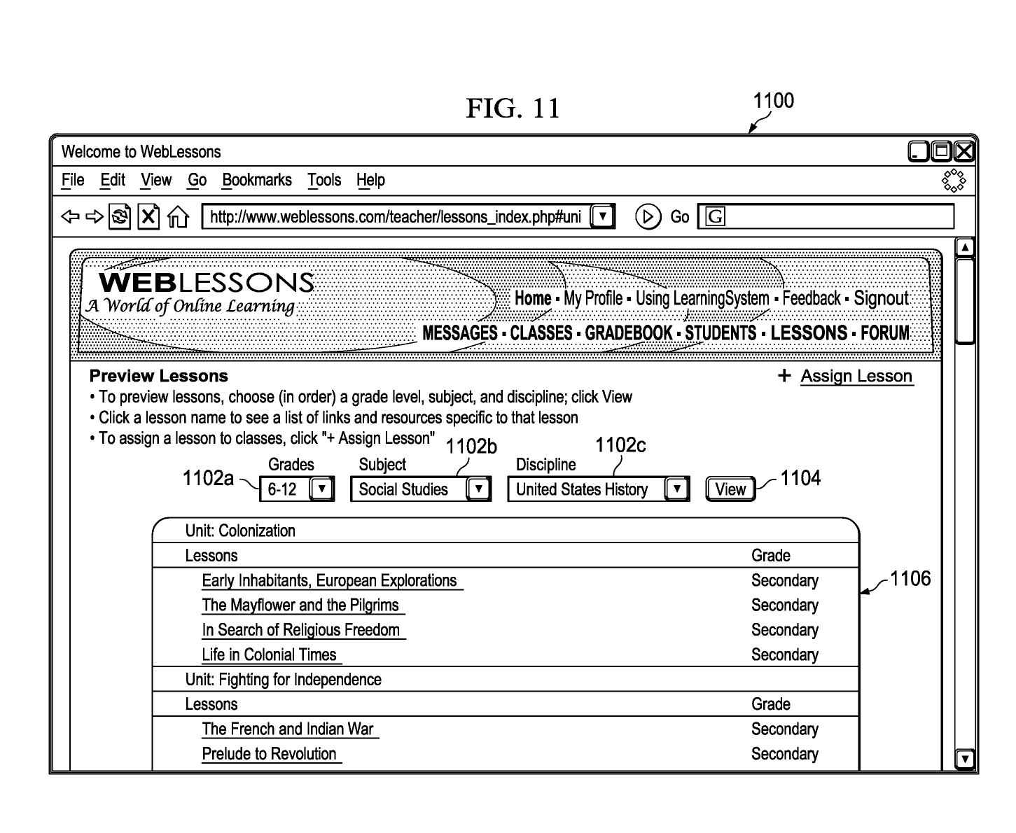

FIG. 11 is an exemplary preview lessons webpage 1100 may provide the teacher user with the ability to preview lessons available on the learning system. The preview lessons webpage 1100 may include a number of search parameters with associated selection elements 1102a, 1102b, and 1102c that may assist the teacher user for searching for a lesson appropriate for his or her particular grade, subject, and discipline, for example. Other searching tools and parameters may additionally and/or alternatively be provided by the learning system to assist the teacher in searching for student lessons. The teacher user may select a soft-button 1104 to view lessons that match the selected parameters. The lessons that match the selected parameters may be displayed in a region 1106 at may be sorted by grades, subjects, disciplines, units, or any other parameter(s).

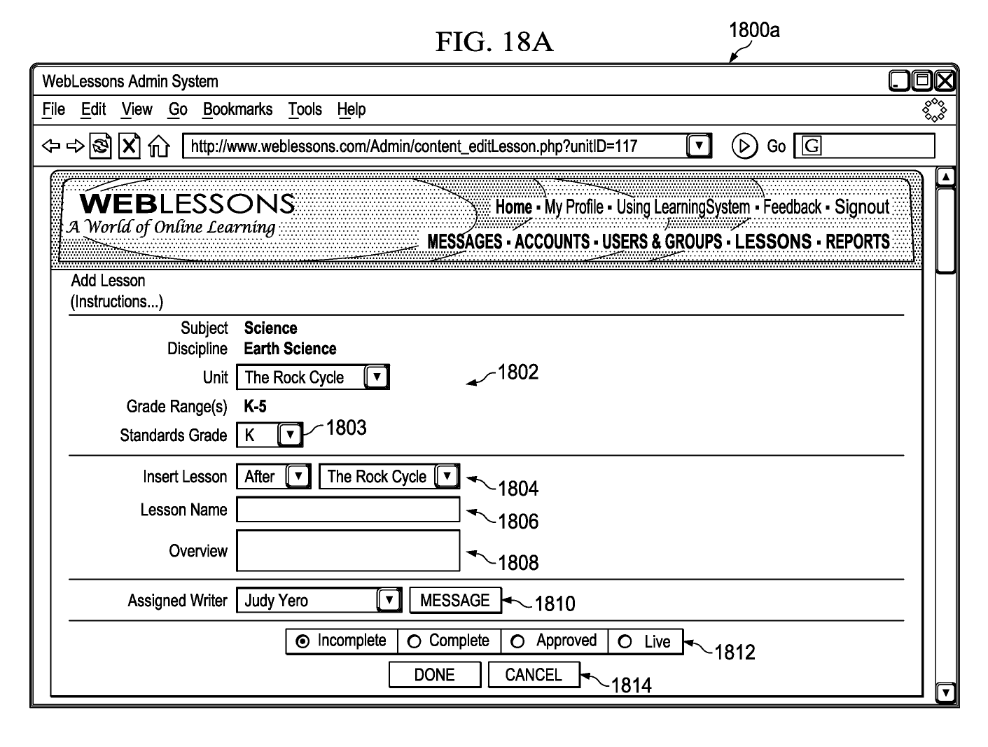

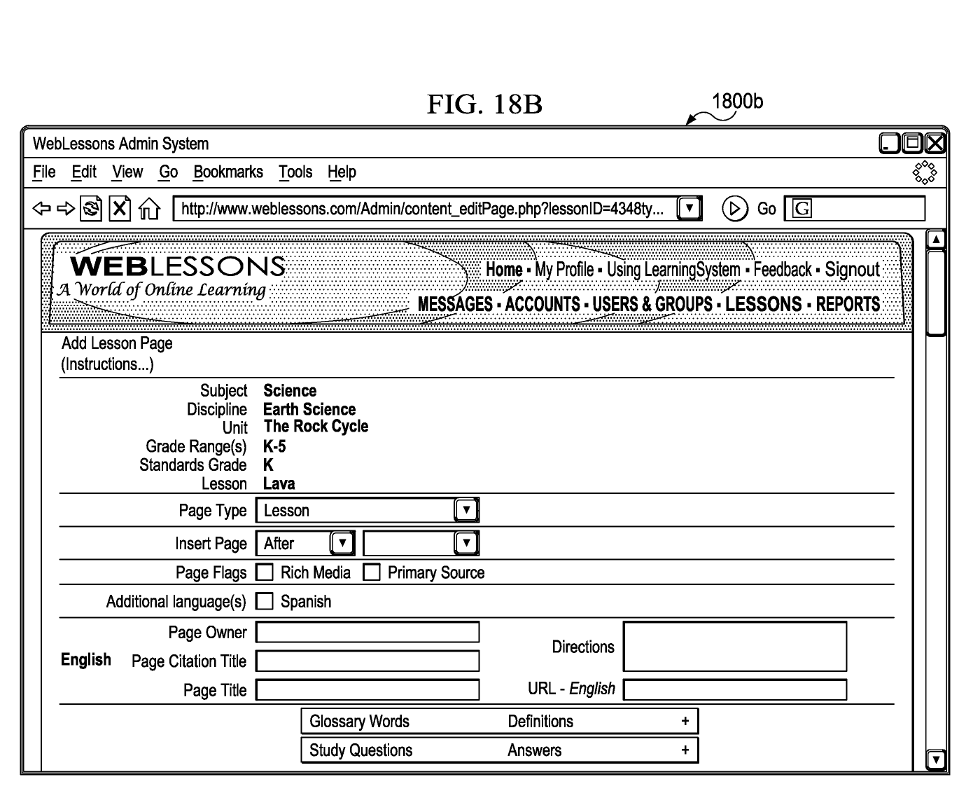

In one embodiment, the learning system may provide for a lesson creator interface, such as one shown in FIGS. 18A and 18B, that enables a teacher or other author, to create his or her own lesson. The lesson creator interface may include text, image, video, and sound entry elements that the teacher may use to enter, upload, or link text, image, video, and sound to create a lesson. In addition, the lesson creator interface may provide for a quiz, pre-and post-quiz, generator to test student knowledge of the lesson. Once complete, the lesson may be assigned grade level, subject, discipline, and other information and made available for a teacher to search, select and assign.

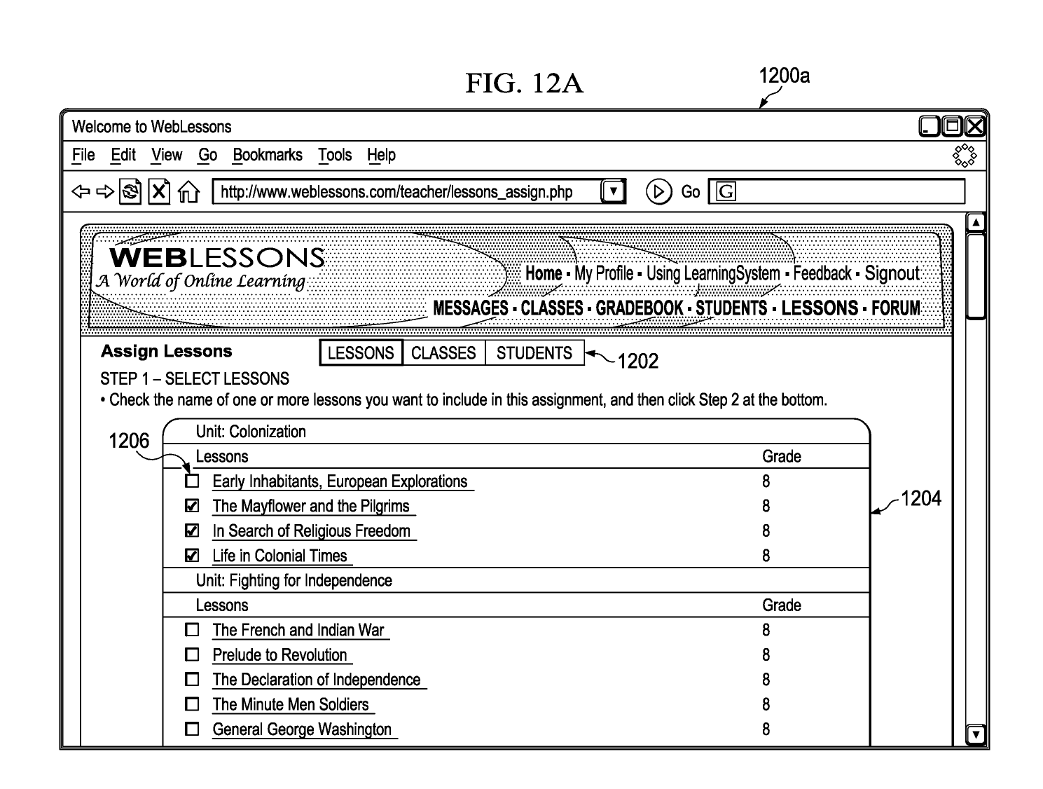

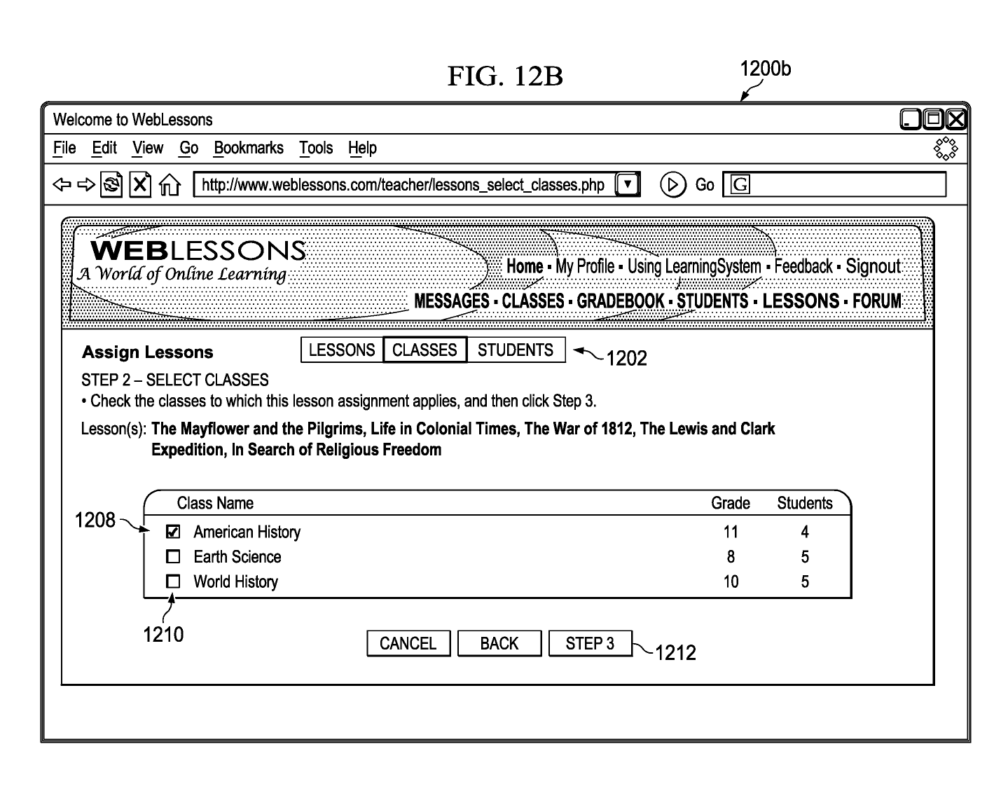

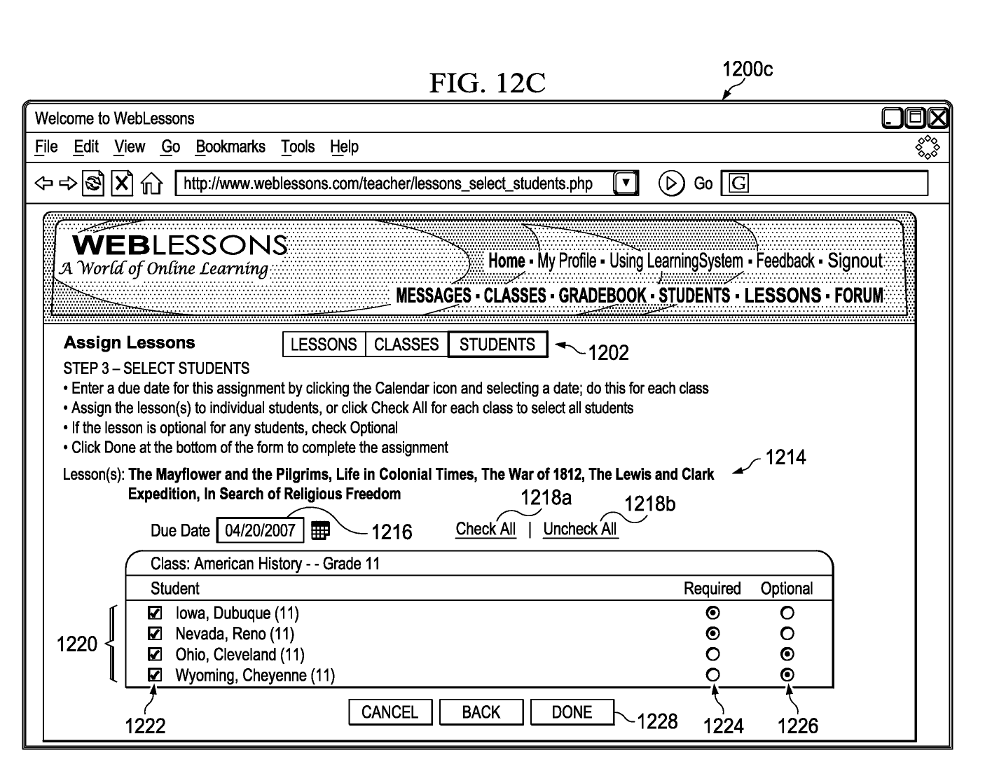

FIG. 12A is a screen shot of an exemplary assign lessons webpage 1200 that enables a teacher to assign lessons to students. In one embodiment, the process for assigning lessons may be a three-step process, which is indicated by three indicators 1202. The first step, indicated as “lessons” by the indicators 1202, includes selecting the name of one or more lessons displayed in a region 1204, optionally sorted by subjects, disciplines, units, grades, etc., to include in an assignment for students. The teacher user may select one or more graphical control element 1206, such as check boxes, to cause the learning system to include the associated lesson in the assignment to the students. The teacher user may select a soft-button (not shown) to continue to step 2 of the lesson assignment process.

FIG. 12B is a screen shot of a second exemplary assign lessons webpage 1200b that provides the second step to assigning lessons to students. The webpage 1200b enables a teacher to assign the selected lessons from the lessons assignment webpage 1200a to one or more classes. A list of classes 1208 may include the grade and number of students in each class. To assign the selected lesson(s) to a class, the teacher user may select one or more graphical control elements 1210. Once the classes are selected, the teacher user may press a soft-button 1212 to continue to step 3 of the lesson assignment process.

FIG. 12C is a screen shot of a third exemplary assign lessons webpage 1200c that provides the third step for assigning lessons to students. The webpage 1200c may provide lesson title(s) 1214 to remind the teacher of the lesson(s) being assigned. The teacher user may select a date that the assignment is due by entering a date in a text entry field 1216 or using a calendar function as understood in the art. The user may select a “check all” option 1218a or “uncheck all” option 1218b of students listed in a list 1220 that shows the names and grades of the students to assign or unassign the selected lesson(s) to all of the students. Alternatively, the teacher user may select graphical control elements 1222 to individually assign the lessons to particular student(s). The teacher user may further make an assignment required or optional by selecting graphical control elements 1224 or 1226 for the selected student(s). Once the teacher user has completed the lesson assignment process, the teacher user may press a soft-button 1228 to notify the learning system that he or she is done with the lesson assignment process. The learning system may, in response, assign the assigned lessons to the selected students and post the assignments on each of the selected students' home pages. A message may additionally be sent to the selected students.

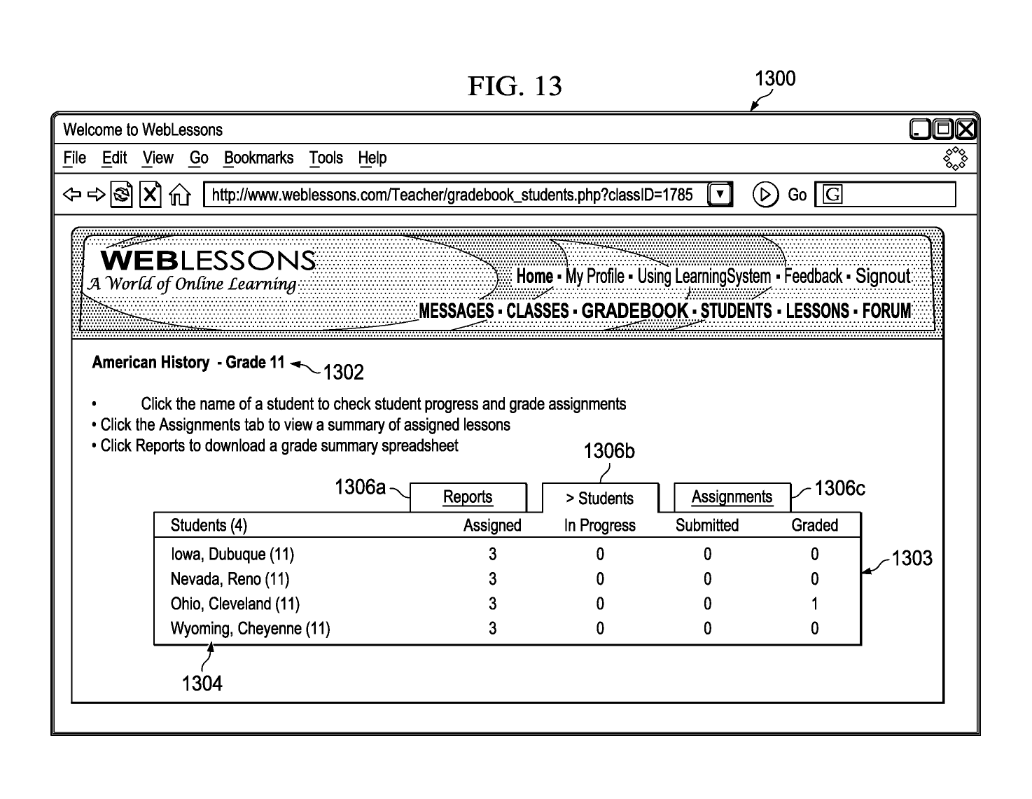

FIG. 13 is a screen shot of an exemplary assignment summary webpage 1300 for a particular class 1302. The assignment summary webpage 1300 may include a table 1303 including a students list 1304 and tabs 1306a -1306c to show status of assignments by the students by different views. A reports tab 1306a may enable the teacher user to download and display a grade summary spreadsheet for each of the assignments completed by the students. A students tab 1036b shows the students and the assignments that have been given to the students. The assignments tab 1306c enables the teacher user to view a summary of the actual assigned lesson. The teacher may view the progress of assignments and grades given to the student by selecting a name of a student.

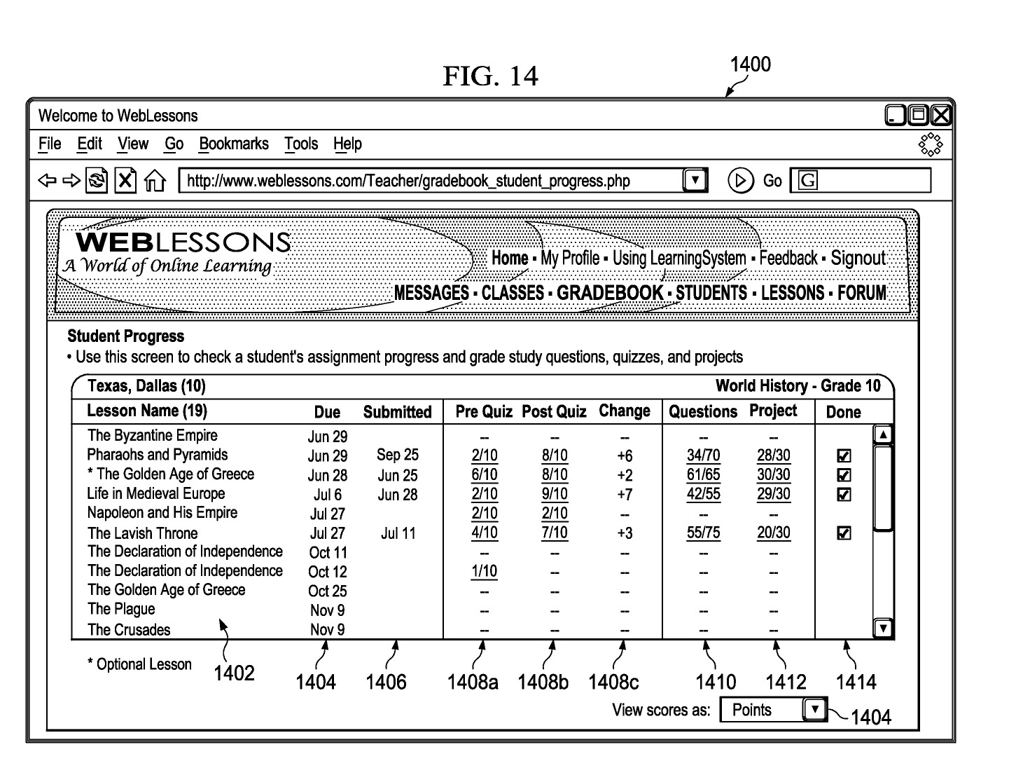

FIG. 14 is a screen shot of an exemplary student progress webpage 1400 that shows the progress of an individual student in completing assignments and grades for each of the assignments. The webpage 1400 may include a list 1402 of lessons, assignment due dates 1404, assignment submission dates 1406, quiz grades, including pre-quiz grades 1408a and post-quiz grades 1408b, change 1408c between pre- and post-quizzes, questions grade 1410, project grade 1412, and assignment done indicator 1414. A score view element 1404 may be used to enable the teacher to view the scores as numbers, percentages, or letters, for example. The teacher user may further select a grade to view details of the assignment and grade assigned. If the student has questioned his or her grade of an assignment, this enables the teacher user to review the assignment to determine whether the grade should be modified.

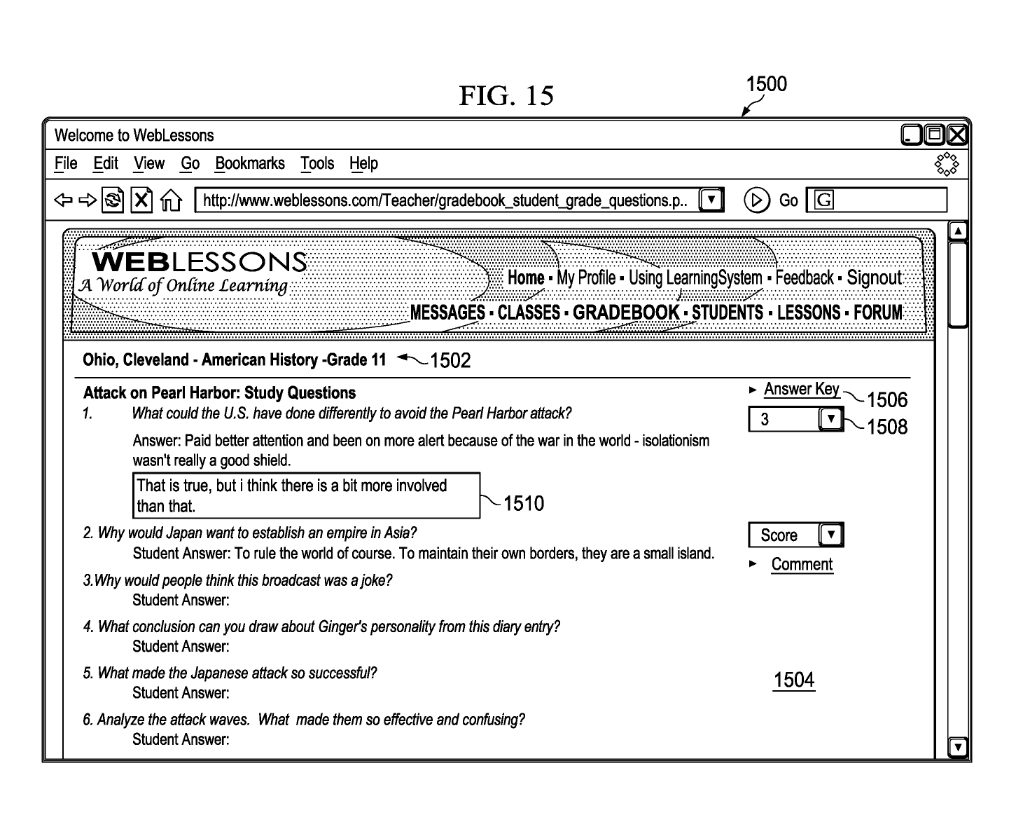

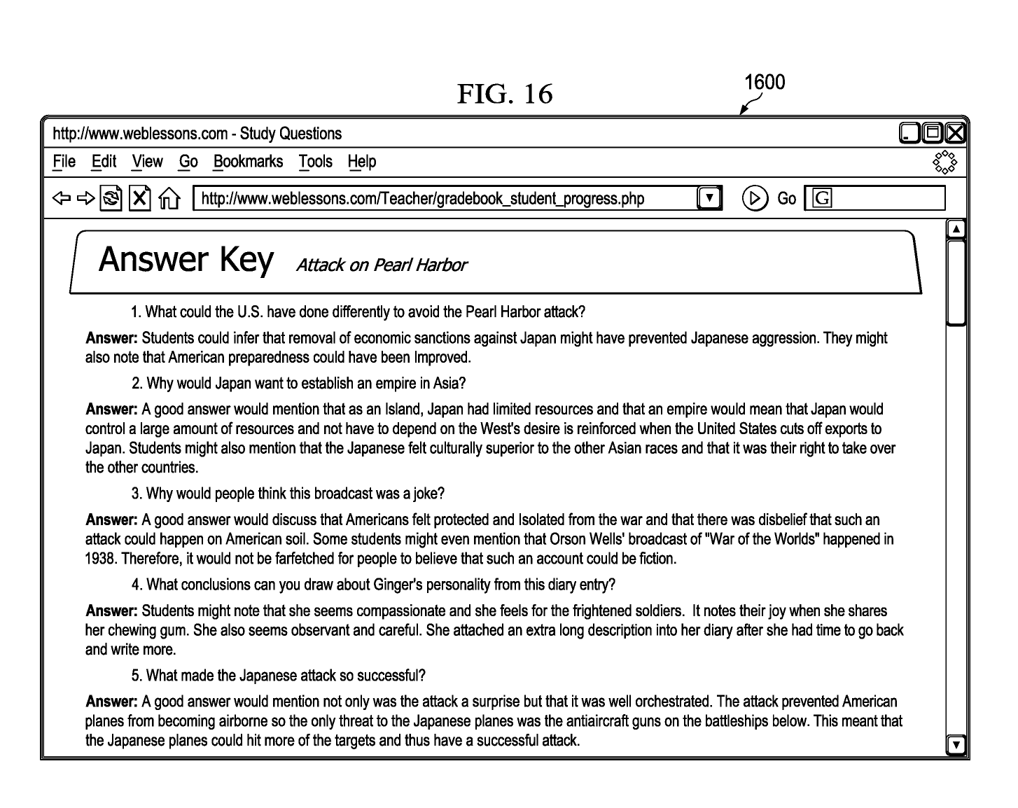

FIG. 15 is a screen shot of an exemplary grading webpage 1500 that enables the teacher to grade a lesson. Information 1502 may provide the teacher with the name, class, and grade of the student. The lesson questions and student answers 1504 may be displayed. The teacher may view an answer key (see FIG. 16) by selecting a hyperlink 1506. The teacher may review the student's answer and assign a grade using a grade selection element 1508. The grades may be configured between 0-10, 0-100, A-F, or any other grading system. A teacher comment box 1510 may be provided to enable the teacher to provide the student with feedback to his or her answer. Although shown as each question receiving an individual grade, groups or all the questions may receive a grade. In addition, the learning system may be configured to enable the teacher to deduct or add points for performance related items, such as timeliness of the submission of the assignment, spelling, punctuation, quality, effort, and other reasons as deemed by the teacher. These extra or deducted points may be automatically generated, such as in the case of submitting the assignment after the due date. The learning system may tally up the grades to provide a total, average, or other mathematical result of the grades given by the teacher. A soft-button (not shown) may be provided for the teacher user to notify the learning system that grading for the lesson is complete and the reviewed assignment may be posted to the student's home page and, optionally, a message may be sent to the student. In addition, the learning system may be configured to send the graded assignment to parents of the student via an email, for example, so that the parents may follow how the student is progressing in his or her classes.

FIG. 16 is a screen shot of an exemplary answer key webpage 1600 that may include the title of the lesson 1602 and questions and model answers to the questions. The teacher may review the model answers prior to grading the students and provide a grade to the student for the correctness and completeness of his or her answers. The answers may include text, graphics, video, or any other form of media to further assist the teacher in grading the students' answers.

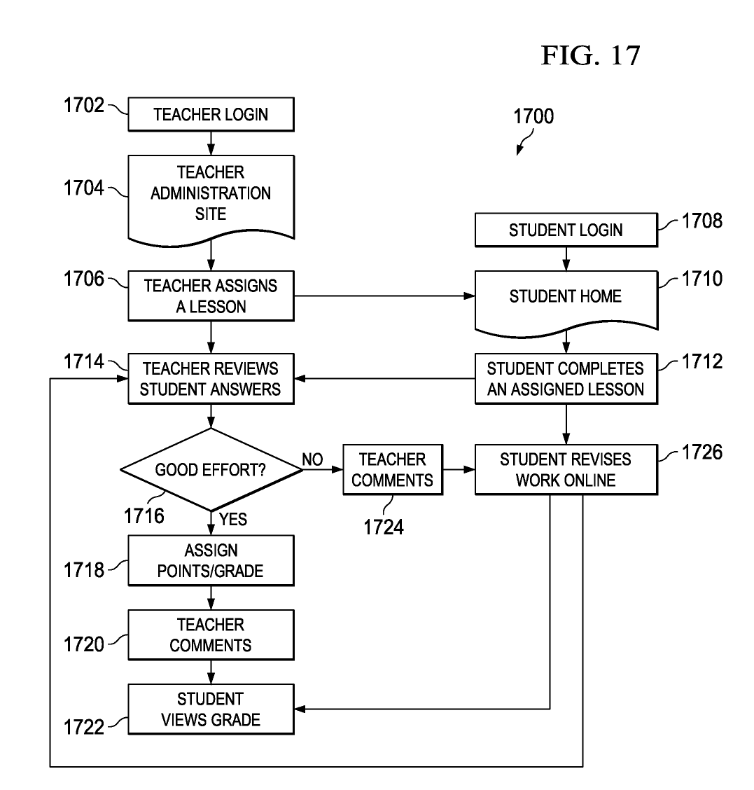

FIG. 17 is a flow diagram of an exemplary process 1700 for operation of the learning system related to assignments. The process starts at step 1702 where a teacher logs into the learning system. The teacher user may access the teacher user administration site (e.g., teacher user home page) at step 1704. At step 1706, the teacher assigns a lesson to a student. The student may log into the learning system at step 1708. At step 1710, the student user may access his or her home page, where he or she may learn of and complete the assigned lesson at step 1712.

At step 1714, the teacher may access the completed lesson by the student and review the student's answers. A determination may be made at step 1716 as to whether the student put forth a good enough effort in completing the assignment. If so, then at step 1718, the teacher may assign points or a grade to the lesson and add comments at step 1720. Steps 1718 and 1720, of course, may be combined. At step 1722, the student may review the graded assignment. If the teacher determined at step 1716 that the student did not make a good enough effort on the assignment, the teacher may provide comments at step 1724, without grading, thereby causing the student to have to revise the assignment at step 1726. Upon the student completing the assignment, the process continues at step 1714 for the teacher to grade the assignment.

FIG. 18A is an add lesson webpage 1800a that allows a lesson developer to create a lesson. The lesson developer may be someone other than the person who created lesson content. In one embodiment, the lesson developer is an educator who works for the learning system provider that finds lessons on the Internet, but was not originally written as part of a textbook meant for classroom instruction. The lesson developer may create the formal instruction content (e.g., directions, quiz, projects, etc.) for the lesson content. Using the add lesson webpage 1800a, the lesson developer may assign general information 1802 for the lesson, including a subject, discipline, unit, and grade range for the lesson. A selectable “standard answers” grade may be selected using a graphical selection element 1804 indicative of the answer key being written for a particular grade. The standard answers grade may inform the teacher of the grade level for which the answer key was written so that students in grades below the standards grade may receive a higher grade for a lesser quality answer and students in grades above the standards grade may receive a lower grade for a lesser quality answer, for example. Lesson assignment elements may enable the lesson developer to insert the lesson in a certain location within a list of lessons. The lesson developer may further provide the lesson with a lesson name 1806 and overview 1808 so that a teacher has an understanding of the lesson at a glance and can more easily determine whether to assign the lesson to students. The assignment writer may also select his or her name 1810 so that a reviewer of the assignment and, possibly, teacher knows who prepared the lesson. A status selection element 1812 may enable the lesson developer to mark the lesson as being incomplete, complete, approved, or live. A soft-button 1814 may be selected when the lesson developer has completed with the information on the webpage 1800a.

FIG. 18B is a screen shot of another add lesson webpage 1800b that enables a lesson developer to provide additional information associated with a lesson, including the page type (e.g., lesson, homework, etc.), page flags (e.g., rich media, primary source), additional languages (e.g., Spanish), page owner, page citation title, page title, directions, URL, glossary words, study questions, summary, project, etc. This information may, at least in part, operate as instruction content that is displayed in association with lesson content. The instruction content that is associated with the lesson content may be arranged in such a manner that, for example, a question is displayed with associated lesson content being displayed. In other words, lesson content provided in a first region may have associated instruction content provided in a second region that is specifically directed to the lesson content current being displayed rather than previously displayed or to be displayed on a later page.

Although particular embodiments of the present invention have been explained in detail, it should be understood that various changes, substitutions, and alterations can be made to such embodiments without departing from the spirit and scope of the present invention as defined solely by the following claims.

What is claimed:

1. A method to provide for learning, said method comprising:
storing lesson information associated with a plurality of lessons, the lesson information including instruction content associated with the lessons;
displaying a graphical user interface including multiple regions on an electronic device of a student user, the graphical user interface including a first region configured to display lesson content and a second region configured to display instruction content, and graphical control elements to enable the student user to control views of lesson information;
locating instruction content of a lesson in response to receiving a request for a selected lesson from the student user using the electronic device;
communicating the instruction content to the electronic device being used by the student user for display in the second region; and
communicating location information of lesson content associated with the selected lesson to the electronic device in response to the student user selecting the lesson, the electronic device, in response to receiving the location information, using the location information to access and display the lesson content in the first region.

2. The method according to claim 1, wherein displaying the graphical control elements includes displaying indicia to display different pages of the lesson content.

3. The method according to claim 1, wherein displaying the lesson content includes displaying information located on a website located at a location on a network included in the location information as authored by someone other than an author of the instruction content.

4. The method according to claim 1, further comprising filtering the lesson content to prevent lesson content having certain words or images from being displayed in the first region.

5. The method according to claim 1, wherein displaying the lesson content includes displaying a hyperlink that, when selected by the student user, causes information located at an address associated with the hyperlink to be displayed in the first region without affecting instruction content being displayed in the second region.

6. The method according to claim 1, wherein displaying instruction content in the second region is associated with displaying the learning content being displayed in the first region.

7. The method according to claim 6, further comprising changing the lesson content and instruction content in response to the student user selecting a graphical control element indicative of a request to display a next page of the lesson content.

8. The method according to claim 1, further comprising:
converting text of the lesson content being displayed into audio signals; and
communicating the audio signals to the student user.

9. The method according to claim 1, further comprising enabling a teacher user to generate instruction content associated with lesson content selectable by the teacher user.

10. The method according to claim 9, further comprising enabling lesson content created by the teacher user to be rated and stored in said database for other teacher users to view.

11. The method according to claim 1, further comprising:
determining that the selected learning content no longer exists at a location included in the location information; and
automatically displaying lesson content other than the selected lesson content in response to determining that the selected learning content no longer exists.

12. The method according to claim 1, further comprising generating a home page for the student user.

13. The method according to claim 12, wherein generating the home page includes displaying at least one list enabling the student user to select a topic within which the lesson content is associated.

14. The method according to claim 1, wherein storing the lesson information includes storing questions and answers associated with the lesson information, and further comprising:
displaying the questions associated with the lesson content; and
displaying the answers in association with answer selection elements for the student to select.

15. The method according to claim 1, further comprising:
generating statistics associated with the student user; and
storing the statistics.

16. The method according to claim 1, further comprising:
storing bibliographic information associated with each lesson; and
storing the bibliographic information in association with displaying the lesson content.

17. The method according to claim 1, further comprising communicating a quiz to be displayed prior to the lesson content being displayed.

18. A graphical user interface, comprising:
a first region configured to display lesson content accessed from a first source location; and
a second region configured to display instruction content, the instruction content including information to provide a student user with directions associated with the lesson content, the instruction content accessed from a second source location different than the first source location.

19. The graphical user interface according to claim 18, wherein the instruction content and lesson content are authored by different authors.

20. The graphical user interface according to claim 18, further comprising a third region within which bibliographic information indicative of the first source location is displayed.

21. The graphical user interface according to claim 18, further comprising a page within which questions associated with the lesson content and selectable answers are displayed, information indicative with the selectable answers being displayed in response to a student user selecting a selectable answer.

22. The graphical user interface according to claim 18, further comprising a question and associated text entry field configured to enable a student user to enter an essay in response to answering the question.

23. The graphical user interface according to claim 18, further comprising a page including preparation information associated with each lesson

24. The graphical user interface according to claim 18, further comprising a home page for each student user.

25. The graphical user interface according to claim 18, further comprising at least one list including topics with which the lesson content is associated.

26. The graphical user interface according to claim 18, further comprising teacher pages to enable a teacher to configure lesson plans for student users.

27. The graphical user interface according to claim 18, further comprising a third region in which statistical information associated with performance of a student user to answer questions associated with the lesson content.
